(19) United States
(12) Patent Application Publication
(10) Pub. No.: US 2024/0031402 A1
(43) Pub. Date: Jan. 25, 2024

(54) SYSTEM AND METHOD FOR SUPPRESSING TRANSMISSIONS FROM A WIRELESS DEVICE

(71) Applicant: CenturyLink Intellectual Property LLC, Broomfield, CO (US)

(72) Inventors: Dean Ballew, Sterling, VA (US); John R.B. Woodworth, Amissville, VA (US)

(73) Assignee: CenturyLink Intellectual Property LLC, Broomfield, CO (US)

(21) Appl. No.: 18/338,778

(22) Filed: Jun. 21, 2023

Related U.S. Application Data
(60) Provisional application No. 63/368,804, filed on Jul. 19, 2022.

(51) Int. Cl. H04L 9/40; H04W 12/125; H04L 41/0659

(52) U.S. Cl. CPC H04L 63/1458; H04W 12/125; H04L 41/0661

(57) ABSTRACT

When several devices communicate through a wireless network, a device may, for example, as a result of having been compromised, transmit an unacceptably high level of traffic, which may interfere with the ability of other devices to communicate through the network, and which may burden the processing resources of devices receiving the traffic. As such, a system and method for suppressing transmissions from a wireless device are provided.

### CROSS-REFERENCE TO RELATED APPLICATIONS

This application claims the benefit of U.S. Provisional Application No. 63/368,804 filed Jul. 19, 2022, entitled “System and Method for Suppressing Transmissions from a Wireless Device,” which is incorporated herein by reference in its entirety.

### FIELD

One or more aspects of examples according to the present disclosure relate to wireless networking, and more particularly to a system and method for suppressing transmissions from a wireless device.

### BACKGROUND

When several devices communicate through a wireless network, a device may, for example, as a result of having been compromised, transmit an unacceptably high level of traffic, which may interfere with the ability of other devices to communicate in the network, and which may burden the processing resources of devices receiving the traffic.

It is with respect to this general technical environment that aspects of the present disclosure are related.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

In aspects, a wireless network interface circuit and associated methods are provided. In an aspect, a wireless network interface circuit is provided comprising: a wireless interface; and a processing circuit, the processing circuit being configured to: receive a shutdown command through the wireless interface; transition to a limited activity state, in response to the receiving of the shutdown command; and operate in the limited activity state, the operating in the limited activity state comprising generating wireless transmissions at a rate not exceeding a threshold.

In another aspect, a wireless network interface circuit is provided, comprising: a host interface; a wireless interface; a processing circuit; and a memory, the memory storing instructions that when executed by the processing circuit cause the wireless network interface circuit to: receive a shutdown command through the wireless interface; transition to a limited activity state, in response to the receiving of the shutdown command; and operate in the limited activity state, the operating in the limited activity state comprising generating wireless transmissions at a rate not exceeding a threshold, wherein the instructions are not modifiable via a command or data received through the wireless interface or through the host interface.

In an aspect, a method includes receiving, by a wireless network interface circuit, through a wireless interface of the wireless network interface circuit, a shutdown command; transitioning, by the wireless network interface circuit, to a limited activity state, in response to the receiving of the shutdown command; and operating, by the wireless network interface circuit, in the limited activity state, the operating in the limited activity state including generating no wireless transmissions or generating wireless transmissions at a rate not exceeding a threshold.

### BRIEF DESCRIPTION OF THE DRAWINGS

These and other features and advantages of the present disclosure will be appreciated and understood with reference to the specification, claims, and appended drawings wherein:

FIG. 1 is a block diagram of a network, according to an example of the present disclosure;

FIG. 2A is a block diagram of a wireless device, according to an example of the present disclosure;

FIG. 2B is a flowchart of a method, according to an example of the present disclosure;

FIG. 2C is a flowchart of a method, according to an example of the present disclosure;

FIG. 2D is a flowchart of a method, according to an example of the present disclosure;

FIG. 2E is a flowchart of a method, according to an example of the present disclosure; and

FIG. 3 is a block diagram of an operating environment, according to an example of the present disclosure.

### DETAILED DESCRIPTION

Hereinafter, examples will be described in more detail with reference to the accompanying drawings, in which like reference numbers refer to like elements throughout. The present disclosure, however, may be embodied in various different forms, and should not be construed as being limited to only the illustrated examples herein. Rather, these examples are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated. Illustrated or described aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the Figures can comprise one or more machines or devices that are operatively connected to cooperate in order to provide the described system functionality. The following detailed description is therefore not to be taken in a limiting sense, and the scope of the present disclosure is defined by the appended claims and their equivalents.

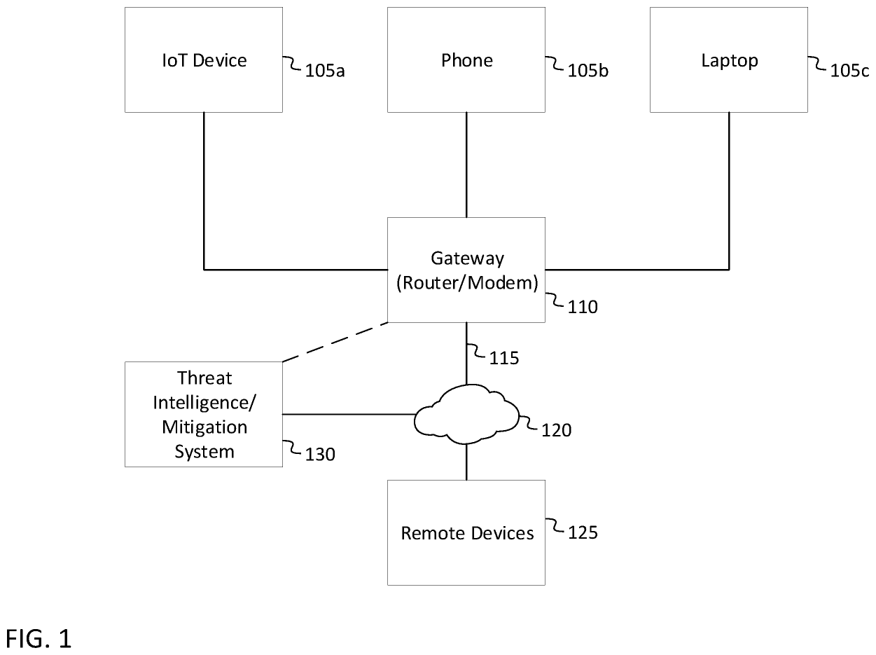

FIG. 1 is a block diagram of a network, in some examples. Each of a plurality of devices, or “stations,” 105a, 105b, 105c (collectively referred to as “devices 105”) is connected to a connecting device 110, e.g., by a wired or wireless connection. The connecting device 110 may have an external connection 115 to one or more other networks 120 (e.g., to the Internet). The devices 105 may include, as illustrated, one or more Internet of Things (IoT) devices, one or more mobile telephones, and one or more computing devices (e.g., laptops); the devices 105 may also include, e.g., file storage systems, printers, and the like. The connecting device 110 may be a hub, a gateway (router/modem combination, as illustrated), a modem, a router, WiFi extender device, or the like. If the connecting device 110 and devices 105 are connected via a WiFi network, then each device 105 may be a non-access-point station (a non-AP STA, or simply a “station”, or STA), and the connecting device 110 may be an access point station (AP STA, or simply AP).

In operation, it may occur that a first device 105a begins to transmit unacceptable traffic, e.g., a volume of traffic that burdens, to an unacceptable extent, the connecting device 110 or its external connection 115, or that interferes with the transmissions of other devices 105b and/or 105c. Such behavior may be caused, for example, by a programming error in code running on the first device, or by malicious code running on the device, as a result of the device's having been compromised, or “infected” by malicious software (or “malware”). If the device 105a has been compromised, the unacceptable traffic may also be directed to other devices 105b and/or 105c or to an external remote device 125, (e.g., to interfere with their operation or to attempt to infect them).

If the connection between the first device 105a and the connecting device 110 is a wired connection, then the connecting device 110 may remedy the problem by simply disregarding all traffic it receives from the first device 105a. If, however, the connections between the devices 105 and the connecting device 110 are wireless connections (e.g., WiFi connections), then (i) the connecting device 110 may not be able to disregard transmissions from the first device 105a entirely, because some decoding of any such transmission may be needed to identify the source of the transmission, and (ii) the unacceptable traffic may interfere with transmissions of other devices 105b, 105c.

As such, in some examples, one or more of the device(s) 105 may be configured to receive a control command (which may be referred to as a “shutdown command”) from the connecting device 110, and, in response, stop sending wireless transmissions, or reduce the rate of wireless transmissions to an acceptable level. During normal operation, a threat intelligence and mitigation system 130 (or “traffic monitor”) may monitor communications within the network, and, upon detecting unacceptable traffic being transmitted by one of the devices 105, transmit, or cause the connecting device 110 to transmit, a shutdown command to the offending device. The threat intelligence and mitigation system 130 may be implemented at least in part on the connecting device 110, or it may be a separate, external piece of hardware, or it may be distributed, e.g., it may include multiple network-connected devices sharing information regarding traffic flows and indications of unusual activity on the network. In addition, threat intelligence and mitigation system 130 may comprise a threat intelligence system and a separate threat mitigation system.

Upon detecting unacceptable traffic being transmitted by one of the devices, the threat intelligence and mitigation system 130 may take additional steps to initiate a process for restoring the device to normal operation, and to avoid infection of other devices on the network. For example, the threat intelligence and mitigation system 130 may log the evidence of unacceptable traffic having been transmitted and the sending of the shutdown command, and it may alert an operator, e.g., a system administrator, of the event, so that the operator may (i) determine whether other devices have been infected, (ii) implement measures to prevent further infections, and (iii) notify and assist the user of the offending device 105. The threat intelligence and mitigation system 130 may also send other notifications, such as a notification to an upstream internet service provider (e.g., if the connecting device is part of a home network).

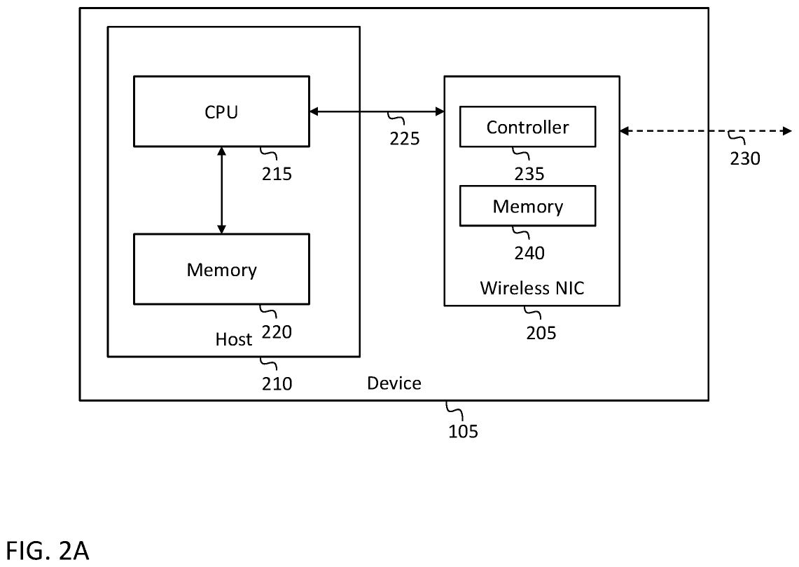

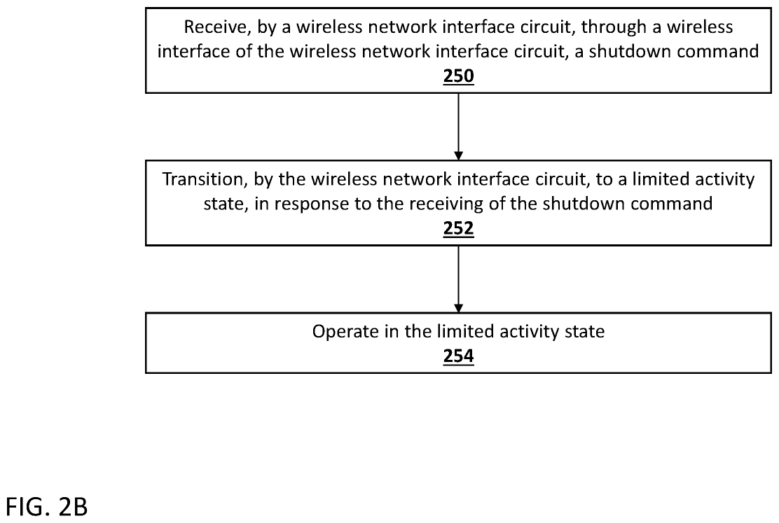

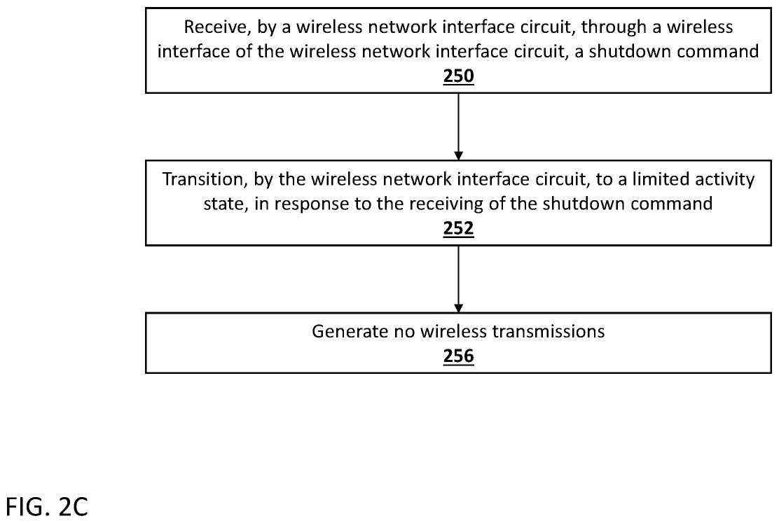

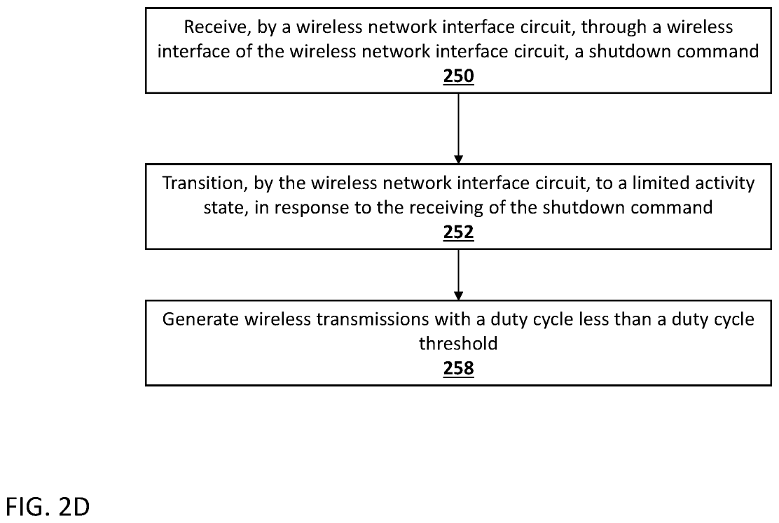

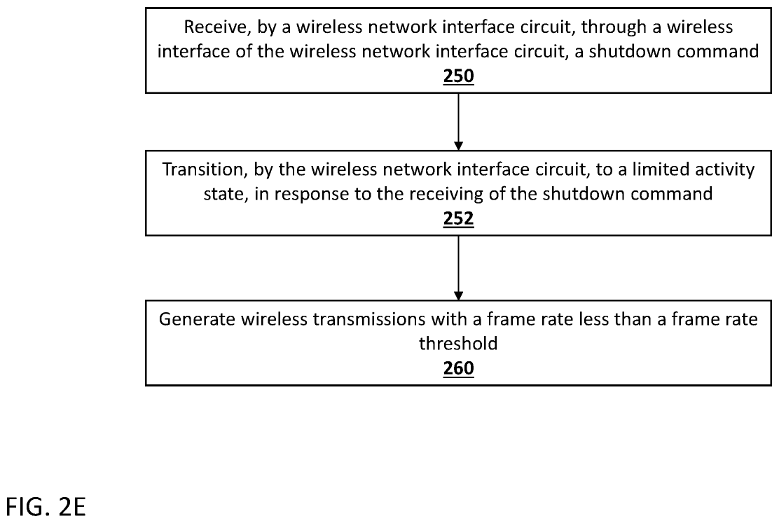

As mentioned above, upon receiving a shutdown command, a device 105 may reduce its level of wireless transmissions. As illustrated in FIG. 2A, each device 105 may include a wireless network interface circuit 205 (or wireless “network interface card” (NIC)) and a host 210. The host 210 may include a processing circuit (e.g., a central processing unit (CPU)) running an operating system and one or more applications (the code for which may be stored in a memory 220), and it may be connected to the wireless network interface circuit 205 by a host interface 225. The host interface may be, or include, a communication link (e.g., a plurality of conductors, or one or more optical fibers) through which the host 210 may communicate with the wireless network interface circuit 205. The wireless network interface circuit 205 may be connected to the connecting device 110 through a wireless interface 230. The wireless interface may be, or include, a radio frequency (RF) transceiver.

The shutdown command may, upon receipt by the device 105, be interpreted by the wireless network interface circuit 205, and, in response, the wireless network interface circuit 205 may transition to a state (which may be referred to as a “limited activity state”) in which it generates wireless transmissions, if at all, at a sufficiently low rate not to interfere significantly with the operation of the wireless network nor to significantly burden the connecting device 110. For example, in the limited activity state, the wireless network interface circuit 205 may (i) stop generating wireless transmissions entirely, (ii) generate wireless transmissions with a frame rate less than a frame rate threshold (e.g., transmitting fewer than 100 frames per second), or (iii) generate wireless transmissions with a duty cycle less than a duty cycle threshold (e.g., with a duty cycle less than 1%). The frame rate threshold and the duty cycle threshold may be fixed (e.g., hard coded in the wireless network interface circuit 205) or selectable (e.g., specified in the shutdown command).

This state transition may be performed in a manner that the host 210 is not able to interfere with. For example, the wireless network interface circuit 205 may include a controller 235 (which may be a processing circuit) that (i) is implemented as a state machine that performs the transition to the limited activity state without fetching and executing instructions stored in memory (the limited activity state corresponding to a subset of the states of the state machine) or that (ii) operates as a stored-program computer reading and executing instructions from a memory 240 that the host 210 is not capable of modifying (e.g., a memory 240 that is a read-only memory, or to which the host 210 does not have write access). These safeguards may be an obstacle to any malicious code that may infect the device 105 and that, might, were it able to, prevent the wireless network interface circuit 205 from transitioning to the limited activity state.

Upon receiving a shutdown command, the wireless network interface circuit 205 may notify the host 210 (through the host interface 225) that it is transitioning to the limited activity state. The shutdown command may include an explanation for its having been sent, or information or advice for the user of the device 105, and the wireless network interface circuit 205 may relay this explanation, information, or advice to the host. For example, the shutdown command may include a payload with a text string that includes such explanation. In other examples, the shutdown command may include a code in a dedicated explanation field of the shutdown command, which code may correspond to a pre-defined explanation known to the wireless network interface circuit 205 and/or host 210. If the operation of the host 210 remains sufficiently normal (e.g., if an application on the host 210 has become infected, or is sending unacceptable traffic because of a programming error in the application, but the operating system continues to operate normally) then the host may cause the display of the explanation or advice on the device to the user. Such an explanation may, for example, inform the user that the device's wireless connection has been disabled because it was generating unacceptable network traffic, and advise the user to contact a support center (e.g., at a specified telephone number), or a system administrator, for help restoring the device to normal operation. The displaying of the message to the user may be done by the operating system, as a system message, or it may be done, when the user attempts to navigate to a web site using a browser, by instead serving, to the browser, a page (internally generated by the device) notifying the user that the device's wireless connection has been disabled and displaying advice to the user regarding steps to take to restore normal operation.

Upon receiving a shutdown command, the wireless network interface circuit 205 may authenticate the command before transitioning to the limited activity state. This authentication may take the form of (i) verifying the presence, in the shutdown command, of a secret shared by the wireless network interface circuit 205 and only authorized potential senders of shutdown commands, or of (ii) encryption (as verified by decryption, by the wireless network interface circuit 205, using a public key) of a portion of the shutdown command by a private key known only to authorized potential senders of shutdown commands. In the latter case, the encrypted portion of the shutdown command may include a timestamp to help prevent replay attacks.

The shutdown command may be sent as a single frame (e.g., a single WiFi frame, which may have a maximum payload size of 2304 bytes); the use of a single frame may avoid any dependency for reassembly, reordering, or retransmissions. The shutdown command may include, as mentioned above, a message with an explanation (or a shorthand code for an explanation) for the sending of the shutdown command, or with advice for the user of the device 105. In some examples, the shutdown command contains the text of such a message; in other examples, the shutdown command instead contains a code, which the wireless network interface circuit 205 may translate into a message or relay to the host 210, and which the host 210 may translate into a message to be displayed to the user.

After receiving a shutdown command, the device 105 may remain in the limited activity state for a fixed amount of time (e.g., for five or ten minutes) and then transition automatically back to a normal operating state, in which the wireless network interface circuit 205 does not constrain the rate of wireless transmissions. In other examples, the device may remain in the limited activity state until the power of the wireless network interface circuit 205 is cycled (e.g., turned off and then back on), or until a command (which may be referred to as a “restart command”) is received by the wireless network interface circuit 205.

The restart command may, like the shutdown command, be authenticated by the wireless network interface circuit 205 before the wireless network interface circuit 205 performs a corresponding state transition. The restart command may be received by the wireless network interface circuit 205 through the wireless interface 230, e.g., having been sent by an operator (or programmatically, such as by the threat intelligence/mitigation system 130 or other automated system) that may have determined that (i) the device 105 was not in fact sending unacceptable traffic or that (ii) the cause of the unacceptable traffic has been remedied. In some circumstances the restart command may instead be received by the wireless network interface circuit 205 through the host interface 225. This may make it possible, for example, for a user running a suitable application on the device 105 to key in an authentication code (e.g., received from a help center operator), and for the application then to generate and send the restart command to the wireless network interface circuit 205, restoring it to normal operation.

FIGS. 2B-2E are flowcharts of methods, in some examples. Referring to FIG. 2B, in some examples, a shutdown command is received, at 250, through a wireless interface of a wireless network interface circuit; the wireless network interface circuit, transitions, at 252, to a limited activity state, in response to the receiving of the shutdown command; and the wireless network interface circuit operates, at 254, in the limited activity state, the operating in the limited activity state including generating no wireless transmissions or generating wireless transmissions at a rate not exceeding a threshold. Referring to FIG. 2C, the operating in the limited activity state (at 254 in FIG. 2B) may include generating, at 256, no wireless transmissions. Referring to FIG. 2D, the operating in the limited activity state (at 254 in FIG. 2B) may include generating, at 258, wireless transmissions at a rate not exceeding a threshold, the generating of wireless transmissions at a rate not exceeding a threshold comprising generating transmissions with a duty cycle less than a duty cycle threshold. Referring to FIG. 2E, the operating in the limited activity state (at 254 in FIG. 2B) may include generating, at 260, wireless transmissions at a rate not exceeding a threshold, the generating of wireless transmissions at a rate not exceeding a threshold comprising generating transmissions with an average frame rate less than a frame rate threshold.

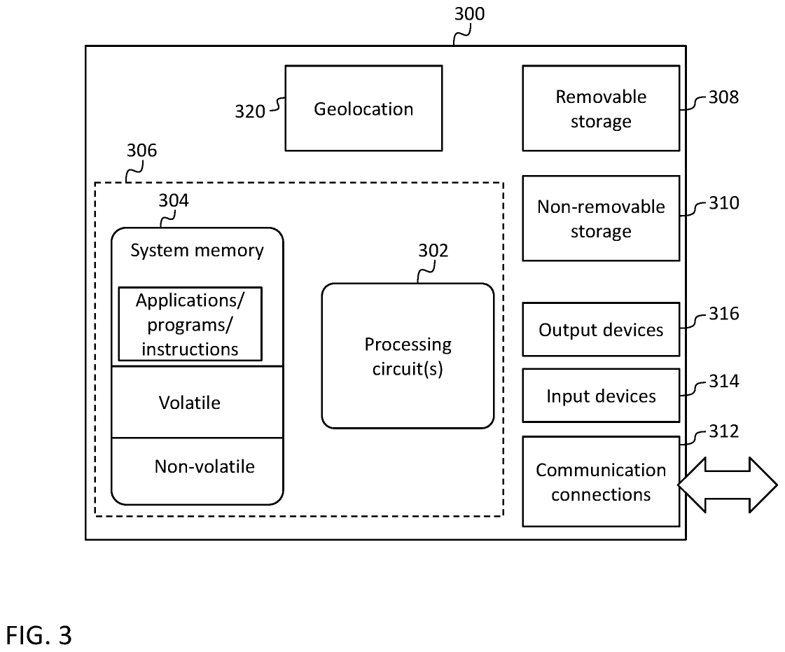

FIG. 3 depicts an example of a suitable operating environment 300, portions of which may be used to implement the devices 105, the connecting device 110, the threat intelligence and mitigation system 130, a user computing device, or other computing devices within the systems discussed herein. In its most basic configuration, operating environment 300 typically includes at least one processing circuit 302 and memory 304. The processing circuit may be a processor, which is hardware. Depending on the exact configuration and type of computing device, memory 304 (storing instructions to perform the methods disclosed herein) may be volatile (such as RAM), non-volatile (such as ROM, flash memory, etc.), or some combination of the two. This most basic configuration is illustrated in FIG. 3 by dashed line 306. The memory 304 stores instructions that, when executed by the processing circuit(s) 302, perform the processes and operations described herein. Further, environment 300 may also include storage (removable 308, or non-removable 310) including, but not limited to, solid-state, magnetic disks, optical disks, or tape. Similarly, environment 300 may also have input device(s) 314 such as keyboard, mouse, pen, voice input, etc., or output device(s) 316 such as a display, speakers, printer, etc. Additional communication connections 312 may also be included that allow for further communication with LAN, WAN, point-to-point, etc. Operating environment 300 may also include geolocation devices 320, such as a global positioning system (GPS) device.

Operating environment 300 typically includes at least some form of computer readable media. Computer readable media can be any available media that can be accessed by processing circuit 302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

Although some examples are described herein in the context of a WiFi network, the present disclosure is not limited to such a network and, for example, the systems and methods described herein may be employed to similar or identical effect in other wireless networks. As used herein, the word “or” is inclusive, so that, for example, “A or B” means any one of (i) A, (ii) B, and (iii) A and B. As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity. As used herein, when an action is performed “in response to” an event or condition, the event or condition may or may not be necessary to trigger the performance of the action and the event or condition may or may not be sufficient to trigger the performance of the action. For example, if the occurrence of a first event and a second event triggers the performance of an action, it may be said that the action is performed in response to the first event and that it is further performed in response to the second event.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

When a certain example may be implemented differently, a specific process order may be different from the described order. For example, two consecutively described processes may be performed at the same or substantially at the same time, or may be performed in an order opposite to the described order.

The terminology used herein is for the purpose of describing particular examples and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing examples of the present disclosure refers to “one or more examples of the present disclosure.” As used herein, the terms “use,” “using,” and “used” may be considered synonymous with the terms “utilize,” “utilizing,” and “utilized,” respectively.

The electronic or electric devices and/or any other relevant devices or components according to examples of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Although some examples have been described, those skilled in the art will readily appreciate that various modifications are possible in the examples without departing from the spirit and scope of the present disclosure. It will be understood that descriptions of features or aspects within each example should typically be considered as available for other similar features or aspects in other examples, unless otherwise described. Thus, as would be apparent to one of ordinary skill in the art, features, characteristics, and/or elements described in connection with a particular example may be used singly or in combination with features, characteristics, and/or elements described in connection with other examples unless otherwise specifically indicated. Therefore, it is to be understood that the foregoing is illustrative of various examples and is not to be construed as limited to the specific examples disclosed herein, and that various modifications to the disclosed examples, as well as other example embodiments, are intended to be included within the spirit and scope of the present disclosure as defined in the appended claims, and their equivalents.

What is claimed is:

1. A wireless network interface circuit, comprising:
a wireless interface; and
a processing circuit,
the processing circuit being configured to:
receive a shutdown command through the wireless interface;
transition to a limited activity state, in response to the receiving of the shutdown command; and
operate in the limited activity state, the operating in the limited activity state comprising generating wireless transmissions at a rate not exceeding a threshold.

2. The wireless network interface circuit of claim 1, wherein the operating in the limited activity state comprises generating no wireless transmissions.

3. The wireless network interface circuit of claim 1, wherein the generating of wireless transmissions at a rate not exceeding a threshold comprising generating transmissions with a duty cycle less than a duty cycle threshold.

4. The wireless network interface circuit of claim 1, wherein the generating wireless transmissions at a rate not exceeding a threshold comprising generating transmissions with an average frame rate less than a frame rate threshold.

5. The wireless network interface circuit of claim 1, further comprising a host interface, wherein the processing circuit is configured to not modify the response to a shutdown command in response to a command or data received through the wireless interface or through the host interface.

6. The wireless network interface circuit of claim 5, wherein the processing circuit comprises a state machine configured to operate in either the limited activity state or a normal state.

7. The wireless network interface circuit of claim 5, further comprising a memory storing instructions that when executed by the processing circuit cause the processing circuit to cause the wireless network interface circuit to transition to the limited activity state, wherein the instructions are not modifiable via a command or data received through the wireless interface or through the host interface.

8. The wireless network interface circuit of claim 1, wherein the transitioning to a limited activity state is further in response to authenticating the shutdown command.

9. The wireless network interface circuit of claim 1, wherein the processing circuit is configured to cause the wireless network interface circuit to transition from the limited activity state to a normal state upon powering down and powering up of the wireless network interface circuit.

10. The wireless network interface circuit of claim 1, wherein the processing circuit is further configured to:
receive a restart command; and
transition from the limited activity state to a normal state in response to the receiving of the restart command.

11. The wireless network interface circuit of claim 10, wherein the receiving of the restart command comprises receiving the restart command through the wireless interface.

12. The wireless network interface circuit of claim 10, further comprising a host interface, wherein the receiving of the restart command comprises receiving the restart command through the host interface.

13. The wireless network interface circuit of claim 1, further comprising a host interface, wherein the processing circuit is further configured to:
send a notification, through the host interface, in response to the receiving of the shutdown command.

14. The wireless network interface circuit of claim 13, wherein the shutdown command comprises a message, and the notification comprises an indication of the message.

15. A wireless network interface circuit, comprising:
a host interface;
a wireless interface;
a processing circuit; and
a memory,
the memory storing instructions that when executed by the processing circuit cause the wireless network interface circuit to:
receive a shutdown command through the wireless interface;
transition to a limited activity state, in response to the receiving of the shutdown command; and
operate in the limited activity state, the operating in the limited activity state comprising generating wireless transmissions at a rate not exceeding a threshold,
wherein the instructions are not modifiable via a command or data received through the wireless interface or through the host interface.

16. A method, comprising:
receiving, by a wireless network interface circuit, through a wireless interface of the wireless network interface circuit, a shutdown command;
transitioning, by the wireless network interface circuit, to a limited activity state, in response to the receiving of the shutdown command; and
operating, by the wireless network interface circuit, in the limited activity state, the operating in the limited activity state comprising generating wireless transmissions at a rate not exceeding a threshold.

17. The method of claim 16, wherein the operating in the limited activity state comprises generating no wireless transmissions.

18. The method of claim 16, wherein the generating of wireless transmissions at a rate not exceeding a threshold comprising generating transmissions with a duty cycle less than a duty cycle threshold.

19. The method of claim 16, wherein the generating wireless transmissions at a rate not exceeding a threshold comprising generating transmissions with an average frame rate less than a frame rate threshold.

20. The method of claim 16, wherein the wireless network interface circuit is configured to not modify the response to a shutdown command in response to a command or data received through a wireless interface of the wireless network interface circuit or through a host interface of the wireless network interface circuit.
